(19) United States
(12) Patent Application Publication
(10) Pub. No.: US 2023/0289689 A1
(43) Pub. Date: Sep. 14, 2023

(54) PRODUCTION PLAN DISPLAY SYSTEM FOR SHAPED ARTICLE

(71) Applicant: SEIKO EPSON CORPORATION, Tokyo (JP)

(72) Inventor: Soji SHIOZAWA, Matsumoto (JP)

(21) Appl. No.: 18/182,415

(22) Filed: Mar. 13, 2023

(30) Foreign Application Priority Data
Mar. 14, 2022 (JP) 2022-039012
Mar. 14, 2022 (JP) 2022-039021

(51) Int. Cl. G06Q 10/0631; G06Q 50/04; G06F 3/0488

(52) U.S. Cl. CPC G06Q 10/06316; G06Q 50/04; G06F 3/0488; G06F 2203/048

(57) ABSTRACT

A production plan display system for a shaped article includes a display unit configured to display a screen showing production plans for shaped articles of a plurality of types. On the screen, information on the shaped articles of each type is displayed in accordance with priority rankings for changing the production plans. The priority rankings are determined in accordance with information on a production deadline of the shaped articles of each type, information on a stock of the shaped articles of each type, and information on a production status of the shaped articles of each type.

The present application is based on, and claims priority from JP Application Serial Number 2022-039021, filed Mar. 14, 2022, and JP Application Serial Number 2022-039012, filed Mar. 14, 2022, the disclosure of which is hereby incorporated by reference herein in its entirety.

### BACKGROUND

### 1. Technical Field

The present disclosure relates to a production plan display system for a shaped article.

### 2. Related Art

Regarding a production plan for a shaped article, for example, JP-A-6-231136 (Patent Literature 1) discloses the following: when a certain type of article is to be produced, equipment most suitable for the type of article is sequentially selected from among available equipment, it is determined whether the type of article can be changed in the selected equipment and whether a mold necessary for production can be used in the selected equipment, and products are allocated for each day from the first day to the last day in an allocation period, thereby creating a production plan.

In an actual shaping site, a production plan may be forced to be modified due to a sudden change in delivery date of a customer, a change in order quantity, a delay in production due to a malfunction in equipment, or the like. In this case, there is a possibility that production of a shaped article is not in time for a delivery date thereof only by considering availability of the equipment. Therefore, there has been a demand for a technique capable of preventing an occurrence of a delay in production in changing the production plan.

### SUMMARY

According to an aspect of the present disclosure, a production plan display system for a shaped article is provided. The production plan display system includes a display unit configured to display a screen showing production plans for shaped articles of a plurality of types. On the screen, information on the shaped articles of each type is displayed in accordance with priority rankings for changing the production plans. The priority rankings are determined in accordance with information on a production deadline of the shaped articles of each type, information on a stock of the shaped articles of each type, and information on a production status of the shaped articles of each type.

### BRIEF DESCRIPTION OF THE DRAWINGS

FIG. 1 is an explanatory diagram illustrating a schematic configuration of a production plan display system.

FIG. 2 is a diagram illustrating an example of a production plan screen.

FIG. 3 is a flowchart illustrating priority ranking area generation.

FIG. 4 is a table for illustrating a priority calculation method.

FIG. 5 is another table for illustrating the priority calculation method.

FIG. 6 is a flowchart illustrating production plan edit area generation.

FIG. 7 is a flowchart illustrating number of production days display.

FIG. 8 is an explanatory diagram illustrating the production plan screen subjected to a change in production plan.

FIG. 9 is an explanatory diagram illustrating another example of the production plan screen subjected to a change in production plan.

### DESCRIPTION OF EXEMPLARY EMBODIMENTS

### A. First Embodiment

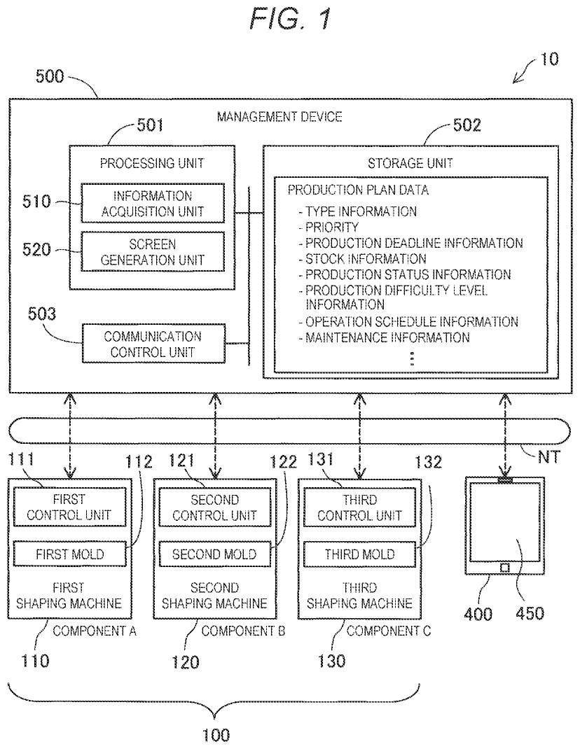

FIG. 1 is an explanatory diagram illustrating a schematic configuration of a production plan display system 10 according to a first embodiment. The production plan display system 10 includes a management device 500 and a terminal device 400. A first shaping machine 110, a second shaping machine 120, a third shaping machine 130, and the terminal device 400 are communicably connected to the management device 500. In the embodiment, the management device 500 is able to communicate with these devices via a network NT. The network NT may be, for example, a LAN, a WAN, or the Internet. The management device 500 is also referred to as a server.

In the embodiment, the first shaping machine 110 is a device that performs injection molding. The first shaping machine 110 includes a first control unit 111, and an injection device and a mold-clamping device (not illustrated). A first mold 112 having a cavity is attached to the mold-clamping device. The first mold 112 in the embodiment is a metal mold. The first mold 112 may be made of ceramic or resin. A material dryer that dries a material or an inspection device that inspects a shaped article may be coupled to the first shaping machine 110.

The first control unit 111 is implemented with a computer including one or a plurality of processors, a storage device, and an input and output interface through which signals are input and output from and to an outside.

The first control unit 111 controls units of the first shaping machine 110 to perform injection molding and shape a shaped article. More specifically, the first control unit 111 controls the mold-clamping device to clamp a mold, and controls the injection device to plasticize a material and inject the plasticized material into the mold, thereby shaping a shaped article having a shape corresponding to a shape of a cavity provided in the mold.

The first control unit 111 can transmit physical quantity information indicating a physical quantity related to injection molding to the management device 500. The physical quantity information includes measurement values obtained by measurement of various sensors provided in the first shaping machine 110 and various command values related to injection molding. The command values are values set in the first shaping machine 110, such as a value of an injection filling time, a value of an injection pressure, and a value of a set temperature. The measurement values are values obtained by the sensors measuring these actual values. In the management device 500, a statistical value or a history of the physical quantity information may be recorded in a storage unit 502 by a processing unit 501 provided in the management device 500.

The second shaping machine 120 includes a second control unit 121. The third shaping machine 130 includes a third control unit 131. A second mold 122 is attached to a mold-clamping device of the second shaping machine 120. A third mold 132 is attached to a mold-clamping device of the third shaping machine 130. The second shaping machine 120 and the third shaping machine 130 have the same configuration as the first shaping machine 110. The second control unit 121 and the third control unit 131 have the same configuration as the first control unit 111. Therefore, a detailed description of the shaping machines and the control units will be omitted. Hereinafter, when the shaping machines 110, 120, and 130 are referred to without being distinguished, the shaping machines 110, 120, and 130 are simply referred to as a shaping machine 100. Without being limited to three shaping machines 100, one or two shaping machines 100 or four or more shaping machines 100 may be coupled to the management device 500.

The terminal device 400 is implemented as a computer that includes one or more processors, a storage device, and a display unit 450. As the terminal device 400, a tablet terminal, a notebook personal computer, a smartphone, a handy terminal, or the like can be applied. Various screens received from the management device 500 are displayed on the display unit 450. In the embodiment, the display unit 450 is provided with a touch panel function.

The management device 500 is implemented by a computer that includes the processing unit 501, the storage unit 502, and a communication control unit 503. The processing unit 501 includes one or more processors and a main storage device. The storage unit 502 is implemented by an auxiliary storage device such as a hard disk drive. The communication control unit 503 includes a communication circuit for controlling communication with other devices such as the shaping machine 100 and the terminal device 400.

The processing unit 501 includes an information acquisition unit 510 and a screen generation unit 520. The information acquisition unit 510 and the screen generation unit 520 are implemented by the processing unit 501 executing a program stored in the storage unit 502. These functions may be implemented by a combination of a plurality of circuits.

The information acquisition unit 510 acquires various types of information from the shaping machine 100. In addition, the information acquisition unit 510 acquires, from the terminal device 400, information on an operation performed on the terminal device 400 by a user.

The storage unit 502 stores production plan data indicating a production plan of a shaped article. The production plan data includes, for example, type information indicating the type of a shaped article as a production target, priority, production deadline information, stock information, production status information, production difficulty level information, operation schedule information of a mold and a shaping machine, and maintenance information of the mold and the shaping machine. The production status information includes information on an operation status of the shaping machine and the mold, and information on a defect of the shaped article. Details of these types of information will be described later. In addition to these types of information, the storage unit 502 stores all pieces of information used for displaying a production plan screen SC1 to be described later.

The screen generation unit 520 generates a production plan screen showing a production plan of a shaped article based on information stored in the storage unit 502. The screen generation unit 520 transmits the generated screen to the terminal device 400. The terminal device 400 acquires the screen generated by the screen generation unit 520 and displays the screen on the display unit 450.

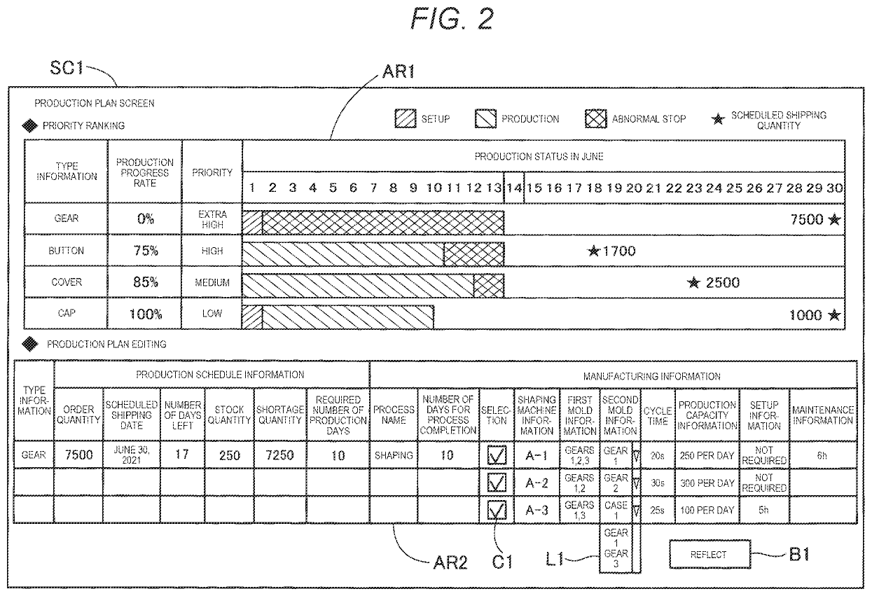

FIG. 2 is a diagram illustrating an example of the production plan screen SC1 generated by the screen generation unit 520 and displayed on the display unit 450. The production plan screen SC1 is a screen for displaying production plans of shaped articles of a plurality of types. In the production plan screen SC1 in the embodiment, a priority ranking area AR1 and a production plan editing area AR2 are arranged. The priority ranking area AR1 is an area in which information on the shaped articles of the plurality of types is displayed according to priority rankings for changing the production plans. The production plan editing area AR2 is an area in which a production plan of a shaped article designated in the priority ranking area AR1 is displayed in an editable manner. In the embodiment, the priority ranking area AR1 and the production plan editing area AR2 are displayed on the same screen. Alternatively, the priority ranking area AR1 and the production plan editing area AR2 may be displayed on separate screens or separate display units. The production plan editing area AR2 may be displayed freely, and the priority ranking area AR1 may be displayed alone.

In the priority ranking area AR1, “type information”, “production progress rate”, “priority”, and “production status” are displayed in association with one another.

The “type information” indicates a type of a shaped article shaped by the shaping machine 100. In FIG. 2, four types “gear”, “button”, “cover”, and “cap” are shown as the type information. The type information may indicate a lot and/or an order source of a shaped article. That is, even the same shaped articles may be classified as shaped articles of different types if lots and/or order sources thereof are different.

The “production progress rate” indicates a ratio of a production quantity at the present time to a scheduled shipping quantity of the month for each type of shaped articles. The production progress rate may indicate progress of a year or a day instead of a month.

The “priority” is information on a priority ranking of changing a corresponding production plan. FIG. 2 shows priorities including “extra high”, “high”, “medium”, and “low” in a descending order. The higher the priority, the greater the necessity to change the corresponding production plan. For example, in the example illustrated in FIG. 2, the “gear” has the highest priority. In the example illustrated in FIG. 2, the various types of information are arranged in accordance with the priority rankings such that a type of shaped articles having a higher priority is positioned to be higher on the screen.

The “production status” indicates an operation state of each shaping machine from the beginning to the end of a month in time series. In FIG. 2, three types “setup”, “production”, and “abnormal stop” are shown as operation states of the shaping machine. The “setup” means that preliminary preparation such as replacement of a mold or replacement of a material for operating the shaping machine is performed on the corresponding day. The “production” indicates that a shaped article was produced on the corresponding day. The “abnormal stop” indicates that the shaping machine 110 is abnormally stopped on the corresponding day. In a production status display area, a scheduled shipping date is indicated by a star mark on the corresponding date, and a scheduled shipping quantity is displayed in association with the scheduled shipping date. When a plurality of shaping machines are used for one type of shaped articles in the “type information”, operation statuses of the shaping machines may be displayed in time series, or average values of the operation statuses of the shaping machines may be displayed. A period indicating a production status may be a year or a day instead of a month.

In the production plan editing area AR2, the “type information”, “production schedule information”, and “manufacturing information” are displayed in association with one another. The production schedule information is also referred to as “shipping information”.

The “type information” is information on the type of a shaped article whose production plan is to be changed. In FIG. 2, “gear” is shown as the type of the shaped article.

The “production schedule information” is information on a production schedule of the shaped article. The production schedule information includes, in association with the type information of the shaped article, an “order quantity” of the shaped article, a “scheduled shipping date”, the “number of days left” up to the scheduled shipping date, a “stock quantity” at the present time, a “shortage quantity” at the present time, and the “required number of production days” indicating the number of days for producing the shaped article corresponding to the shortage quantity. As described, the production schedule information includes information on time such as the scheduled shipping date and the number of days left, information on quantity such as the order quantity, and the like.

The “manufacturing information” includes a “process name”, the “number of days for process completion”, “shaping machine information”, “first mold information”, “second mold information”, “cycle time”, “production capacity information”, “setup information”, and “maintenance information” in association with the type information of the shaped article.

The “process name” indicates a name of a process for producing a shaped article. As the process name, “shaping” is shown in FIG. 2. The “number of days for process completion” indicates the number of days required for a process to complete. In the example illustrated in FIG. 2, the shaped article is produced only by a shaping process. Therefore, the required number of production days included in the production schedule information is the same as the number of days for process completion.

The “shaping machine information” is information on a shaping machine capable of producing a shaped article indicated by the “type information”. In FIG. 2, three shaping machines “A-1”, “A-2”, and “A-3” are shown as shaping machines capable of producing the “gear”. The three shaping machines correspond to, for example, the first shaping machine 110, the second shaping machine 120, and the third shaping machine 130 illustrated in FIG. 1.

The “first mold information” is information on a mold capable of producing a shaped article indicated by the “type information”. In the production plan screen SC1, the “first mold information” is displayed so as to correspond to the “shaping machine information”. In FIG. 2, three types of molds “gear 1”, “gear 2”, and “gear 3” are displayed as the first mold information with respect to the shaping machine “A-1”. Two types of molds “gear 1” and the “gear 2” are displayed as the first mold information with respect to the shaping machine “A-2”. Further, two types of molds “gear 1” and the “gear 3” are displayed as the first mold information in association with the shaping machine “A-3”.

In the production plan screen SC1 illustrated in FIG. 2, the mold “gear 3” is not associated with the shaping machine “A-2”, and the mold “gear 2” is not associated with the shaping machine “A-3”. These combinations are known in advance to have a high defect rate due to individual differences of the shaping machines or the molds, and are excluded from targets to be displayed on the production plan screen SC1 in order to be excluded from options for the user. In another embodiment, all combinations may be displayed without excluding in advance the combinations having a high defect rate from the options. In this case, the defect rates of the respective combinations may be displayed on the production plan screen SC1 or another screen to allow the user to determine the combination.

The “second mold information” is information on a mold attached to the corresponding shaping machine. The second mold information is displayed so as to correspond to the first mold information. In FIG. 2, the mold “gear 1” is attached to the shaping machine “A-1”, and the mold “gear 2” is attached to the shaping machine “A-2”. Both the “gear 1” and the “gear 2” are molds for shaping the “gear”, but acquisition numbers of the “gear 1” and the “gear 2” are different. The acquisition number refers to the number of shaped articles shaped in one shaping process using the mold. In the production plan screen SC1, the mold “gear 1” attached to the shaping machine “A-1” is included in the first mold information corresponding to the shaping machine “A-1”, and the mold “gear 2” attached to the shaping machine “A-2” is included in the first mold information corresponding to the shaping machine “A-2”. The “gear 1” and the “gear 2” may have the same acquisition number as long as the “gear 1” and the “gear 2” are molds for shaping the “gear”.

In FIG. 2, it is shown that a mold “case 1” is attached to the shaping machine “A-3”. The mold “case 1” is not a mold for shaping a gear, but is a mold that can be attached to the shaping machine “A-3”, and is a mold for shaping a case as a shaped article. In the embodiment, in order to simulate a production plan in which a mold is changed, the second mold information is displayed on the production plan screen SC1 so as to be able to be changed by the user. For example, in FIG. 2, the mold “case 1”, the mold “gear 1”, and the mold “gear 3” are displayed by a drop-down list L1 in a selectable manner.

The “cycle time” indicates the time required for one shaping process by a shaping machine to which a mold indicated by the second mold information is attached.

The “production capacity information” indicates the number of shaped articles shaped per day. The production capacity information is determined by the acquisition number of a mold indicated in the second mold information, the cycle time, and the operating time of a shaping machine per day.

The “setup information” is information on setup for operating a shaping machine. The setup information shown in FIG. 2 indicates the time for replacing a mold shown in the second mold information to operate a shaping machine.

The setup information is displayed correspondingly to the shaping machine information. In FIG. 2, “5 hours” is shown as the setup time required to replace the mold “case 1” attached to the shaping machine “A-3” with another mold.

The “maintenance information” is information on maintenance of a shaping machine or a mold. In the embodiment, the maintenance information indicates the time required for maintenance of a shaping machine or a mold by a scheduled shipping date. In FIG. 2, “6 hours” is shown as the maintenance time of the mold “gear 1” provided in the shaping machine “A-1”.

In the production plan editing area AR2, a check box Cl for selecting a shaping machine to be used for production of a shaped article is arranged in association with a corresponding piece of the shaping machine information. When the user operates the display unit 450 of the terminal device 400 to check the check box Cl, the required number of production days in the production schedule information and the number of days for process completion are updated to information in a case where the shaped article is shaped using the checked shaping machine. For example, if all the check boxes Cl of the three shaping machines are checked, the number of days for process completion and the required number of production days in a case where the shaped article is shaped using the three shaping machines are displayed. That is, in the embodiment, when the shaping machine information is selected from a plurality of pieces of shaping machine information in the production plan editing area AR2, the production schedule information is updated based on the selected shaping machine information.

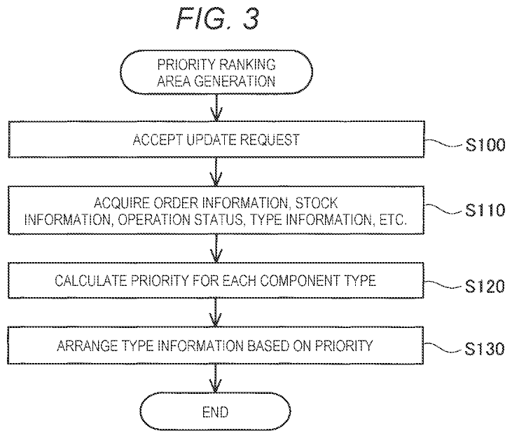

FIG. 3 is a flowchart illustrating priority ranking area generation executed by the processing unit 501 of the management device 500. This processing is for displaying the priority ranking area AR1 in the production plan screen SC1, and is executed, for example, when initially displaying the production plan screen SC1, when changing the production plan, or when a display period of a production status is changed.

In step S100, the processing unit 501 accepts a request to update the priority ranking area AR1 in accordance with a user operation on the display unit 450 or internal processing of the processing unit.

In step S110, the processing unit 501 acquires, from the storage unit 502, various types of information used for calculation of a priority, such as order information including a scheduled shipping quantity, the stock information of a shaped article, operation statuses of shaping machines and molds, and the type information of the shaped article.

In step S120, the processing unit 501 calculates the priority for each component type using the various types of information acquired in step S110. A priority calculation method will be described later.

In step S130, the screen generation unit 520 of the processing unit 501 arranges the type information in accordance with the priorities calculated in step S120 to generate the priority ranking area AR1 illustrated in FIG. 2. Then, the production plan screen SC1 including the priority ranking area AR1 is generated and displayed on the display unit 450 of the terminal device 400.

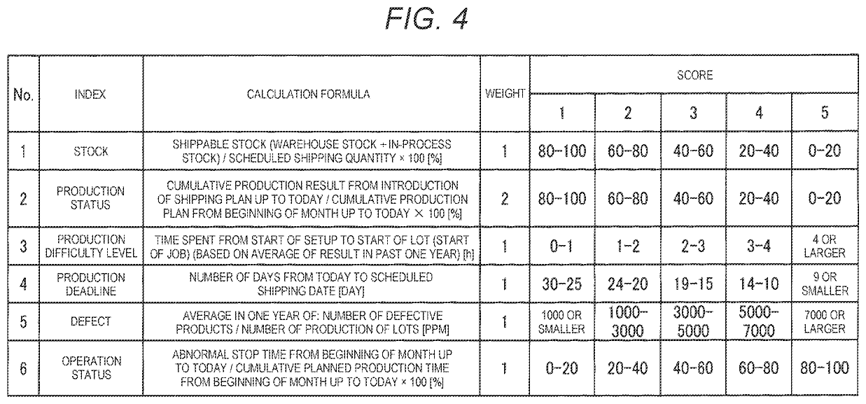

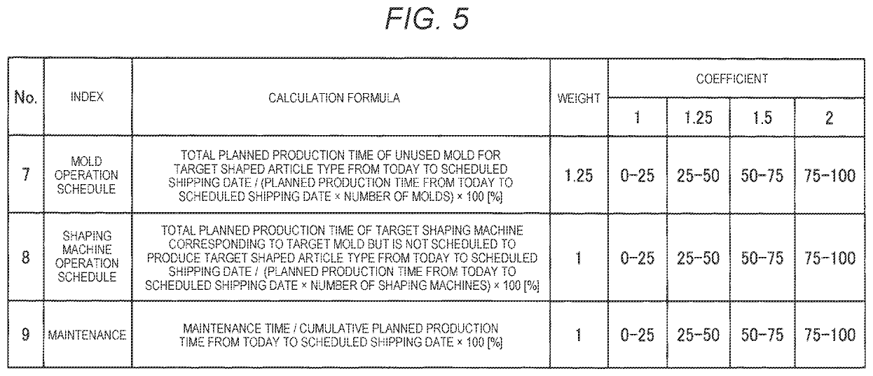

FIGS. 4 and 5 are tables for illustrating the priority calculation method. In step S120, the processing unit 501 multiplies scores of indices shown in No. 1 to No. 6 in FIG. 4 by weights determined for the indices, and calculates a sum of the results as the priority.

As illustrated in FIG. 4, in the embodiment, information on “stock”, “production status”, “production difficulty level”, “production deadline”, “defect”, and “operation status” is used as indices for calculating the priority.

The processing unit 501 determines a score related to the “stock” as follows. First, in accordance with a calculation formula shown in FIG. 4, a ratio of a shippable stock, which is the sum of a warehouse stock and an in-process stock, to the scheduled shipping quantity is calculated. Then, a score in a range from 1 to 5 is determined following a rule that the more the ratio approaches 0% from 100%, the higher the score is. In the example illustrated in FIG. 4, the score related to the stock information is multiplied by a weight 1. The score may be calculated based on an available stock, which is obtained by subtracting an order quantity from an actual stock quantity, instead of the shippable stock.

The processing unit 501 determines a score related to the “production status” as follows. First, in accordance with a calculation formula shown in FIG. 4, a ratio of a number corresponding to a cumulative production result from a time point at which a shipping plan is introduced up to today to a cumulative value on the production plan from the beginning of the month up to today is calculated. Then, a score in a range from 1 to 5 is determined following a rule that the more the ratio approaches 0% from 100%, the higher the score is. In the example illustrated in FIG. 4, the score related to the production status is multiplied by a weight 2.

The processing unit 501 determines a score related to the “production difficulty level” as follows. First, in accordance with a calculation formula shown in FIG. 4, the time based on a result in the past one year from the start of setup to the start of production of a lot is obtained. Then, a score in a range from 1 to 5 is determined following a rule that the more the times approaches 4 hours from 0 hour, the higher the score is. In the example illustrated in FIG. 4, the score related to the production difficulty level is multiplied by a weight 1. The score related to the production difficulty level may be determined in accordance with the number of steps required for setting a production condition of a shaped article, a grade of quality required for the shaped article, a mold size, complexity of a shape of the shaped article, the number of inspection items, and the like.

The processing unit 501 determines a score related to the “production deadline” as follows. First, in accordance with a calculation formula shown in FIG. 4, the number of days from today to the scheduled shipping date is calculated. Then, a score in a range from 1 to 5 is determined following a rule that the more the number of days approaches 1 day from 30 days, the higher the score is. In the example illustrated in FIG. 4, the score related to the production deadline is multiplied by a weight 1.

The processing unit 501 determines a score related to the “defect” as follows. First, in accordance with a calculation formula shown in FIG. 4, an average of ratios of the numbers of defective shaped articles to the numbers of production of lots in one year, that is, an average of defect rates in one year is obtained. Then, a score in a range from 1 to 5 is determined following a rule that the more the average approaches 7000 parts per million (PPM) from 0 PPM, the higher the score is. In the example illustrated in FIG. 4, the score related to the defect is multiplied by a weight 1. The score related to the defect may be determined according to a combination of a shaping machine and a mold, a combination of a shaping machine and a material lot, or a combination of a mold and a material lot.

The processing unit 501 determines a score related to the “operation status” as follows. First, in accordance with a calculation formula shown in FIG. 4, a ratio of the abnormal stop time from the beginning of the month up to today to the cumulative planned production time from the beginning of the month up to today is obtained. Then, a score from 1 to 5 is determined following a rule that the more the ratio approaches 100% from 0%, the higher the score is. In the example illustrated in FIG. 4, the score related to the operation status is multiplied by a weight 1.

The processing unit 501 multiplies the scores of the indices calculated as described above by the weights determined for the indices, and calculates a sum of the results as the priority. Regarding the priority calculated in this manner, a larger value of the priority means a higher probability of occurrence of a production delay and a greater necessity to review the corresponding production plan.

In the embodiment, the processing unit 501 adjusts the weights, by which the indices are multiplied, when calculating the priority. The processing unit 501 uses indices shown in No. 7 to No. 9 in FIG. 5 in calculating coefficients for adjusting the weights.

As illustrated in FIG. 5, in the embodiment, information on “mold operation schedule”, “shaping machine operation schedule”, and “maintenance” is used as indices for adjusting the weights.

The processing unit 501 determines a coefficient related to the “mold operation schedule” as follows. First, in accordance with a calculation formula shown in FIG. 5, a ratio of the total planned production time of a mold that can shape a type of shaped articles as a production target but is not used during a period from today to the scheduled shipping date to a value obtained by multiplying the planned production time from today to the scheduled shipping date by the number of molds is obtained. Then, a coefficient in a range from 1 to 2 is determined following a rule that the larger the value of the ratio is, the larger the value of the coefficient is. Further, the coefficient is multiplied by a weight associated with the mold operation schedule. In the example shown in FIG. 5, the coefficient related to the mold operation schedule is multiplied by a weight 1.25.

The processing unit 501 determines a coefficient related to the “shaping machine operation schedule” as follows. First, in accordance with a calculation formula shown in FIG. 5, a ratio of the total planned production time of a shaping machine that can shape a shaped article type as a production target but is not used during a period from today to the scheduled shipping date to a value obtained by multiplying the planned production time from today to the scheduled shipping date by the number of shaping machines is obtained. Then, a coefficient in a range from 1 to 2 is determined following a rule that the larger the value of the ratio is, the larger the value of the coefficient is. Further, the coefficient is multiplied by a weight associated with the shaping machine operation schedule. In the example shown in FIG. 5, the coefficient related to the shaping machine operation schedule is multiplied by a weight 1. As described above, the coefficient related to the mold operation schedule is multiplied by a weight 1.25. Therefore, in the embodiment, in calculating the priority, the weight of the mold operation schedule is larger than the weight of the shaping machine operation schedule. The “mold operation schedule” or the “shaping machine operation schedule” may be used alone as an index.

The processing unit 501 determines a coefficient related to the “maintenance” as follows. First, in accordance with a calculation formula shown in FIG. 5, a ratio of the maintenance time to the cumulative planned production time from today to the scheduled shipping date is obtained. Then, a coefficient in a range from 1 to 2 is determined following a rule that the larger the value of the ratio is, the larger the value of the coefficient is. Further, the coefficient is multiplied by a weight associated with the maintenance. In the example illustrated in FIG. 5, the coefficient related to the maintenance is multiplied by a weight 1. The maintenance time includes one or both of the maintenance time of a shaping machine and the maintenance time of a mold. When a period in which the maintenance of a shaping machine is performed and a period in which the maintenance of a mold is performed overlap each other, the overlapping time is subtracted from a total maintenance time.

The processing unit 501 multiplies the coefficients calculated for these indices by the weight of any one of No. 1 to No. 6 shown in FIG. 4. In the embodiment, the processing unit 501 multiplies the weights of the production status, the defect, and the operation status shown in FIG. 4 by the coefficients calculated for the mold operation schedule and the shaping machine operation schedule. In addition, the processing unit 501 multiplies the weights of the production status and the operation status shown in FIG. 4 by the coefficient calculated for the maintenance. In this way, the priority can be obtained with higher accuracy.

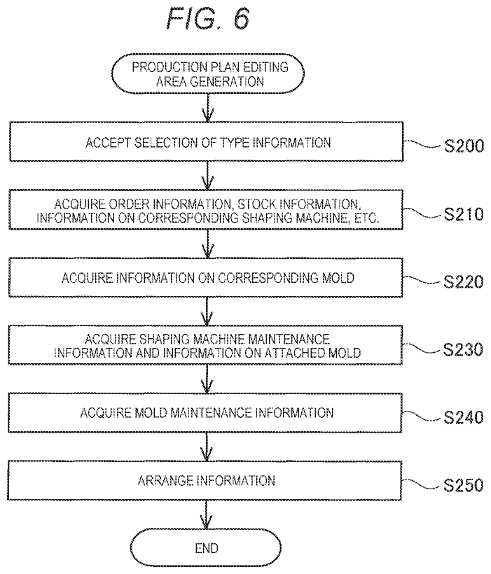

FIG. 6 is a flowchart illustrating production plan editing area generation executed by the processing unit 501. This processing is for generating the production plan editing area AR2 displayed on the production plan screen SC1.

In step S200, the processing unit 501 accepts selection of type information to be changed in a production plan from the priority ranking region AR1 by a user operation on the display unit 450.

In step S210, the processing unit 501 acquires, from the storage unit 502, various types of information used for displaying the production plan editing area AR2, such as order information corresponding to the selected type information, stock information, and information on a shaping machine corresponding to the type.

In step S220, the processing unit 501 acquires, from the storage unit 502, information on a mold corresponding to the shaping machine based on the information on the shaping machine acquired in step S210. A correspondence relationship between the shaping machine and the mold is stored in advance in the storage unit 502.

In step S230, the processing unit 501 acquires, from the storage unit 502, maintenance information of the shaping machine and information on a mold attached to the shaping machine, based on the information on the shaping machine acquired in step S210.

In step S240, the processing unit 501 acquires, from the storage unit 502, maintenance information of the mold based on the information on the mold acquired in step S220.

In step S250, the screen generation unit 520 generates the production plan editing area AR2 in which the pieces of information acquired by the processing unit 501 in steps S210 to S240 are arranged. The generated production plan editing area AR2 is arranged in the production plan screen SC1 and is displayed on the display unit 450 of the terminal device 400.

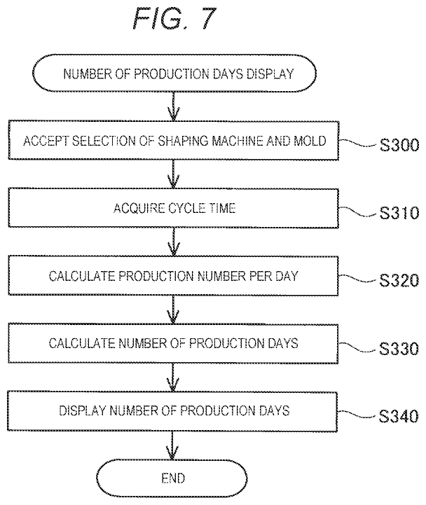

FIG. 7 is a flowchart illustrating number of production days display executed by the processing unit 501. This processing is for displaying the required number of production days in the production plan editing area AR2.

In step S300, the processing unit 501 accepts selection of a shaping machine and a mold from the production plan editing area AR2 by a user operation performed on the display unit 450.

In step S310, the processing unit 501 acquires, from the storage unit 502, the cycle time corresponding to the shaping machine and the mold selected in step S300.

In step S320, the processing unit 501 calculates the production number per day by dividing the total time of the operating time per day and the abnormal stop time per day by the cycle time.

In step S330, the processing unit 501 calculates the number of production days by dividing a shortage quantity, which is obtained by subtracting a stock quantity from an order quantity included in the order information, by the production number per day obtained in step S320.

In step S340, the screen generation unit 520 arranges the number of production days calculated in step S330 in the production plan editing area AR2 as the number of days for process completion and the required number of production days, and causes the display unit 450 to display the number of production days.

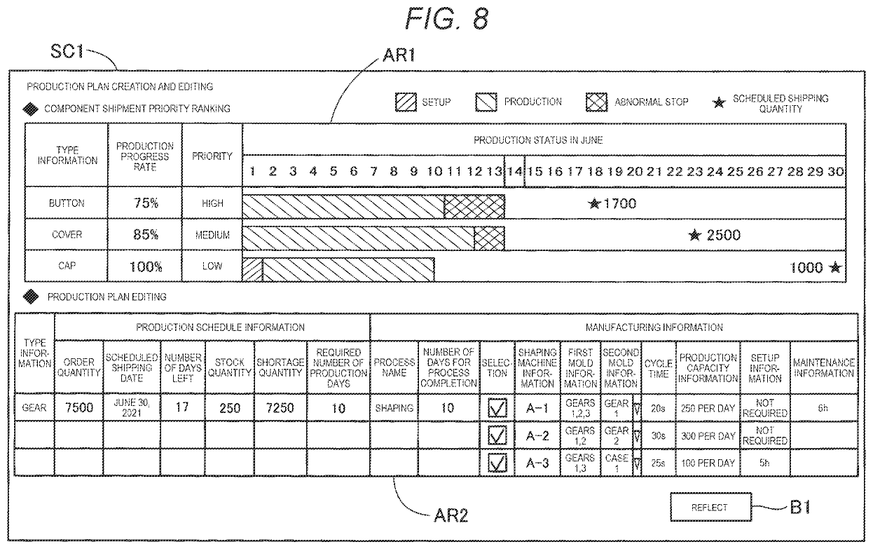

FIG. 8 is an explanatory diagram illustrating the production plan screen SC1 subjected to a change in production plan. A reflection button B1 is provided in the production plan editing area AR2. The user presses the reflection button B1 after confirming on the production plan editing area AR2 that the required number of production days is reduced by the selection of the mold or the shaping machine in the production plan editing area AR2. When the processing unit 501 detects that the user pressed the reflection button B1, the screen generation unit 520 deletes the component type, whose production plan is changed, from the priority ranking area AR1, as illustrated in FIG. 8. FIG. 8 illustrates an example in which the component type “gear” is deleted from the priority ranking area AR1.

According to the production plan display system 10 of the embodiment described above, since type information of a shaped article is displayed according to a priority ranking determined according to information on a production deadline of the shaped article, information on a stock thereof, and information on a production status thereof, the user can change a production plan of the shaped article according to the priority ranking for which not only a current stock but also a current production status is taken into consideration. As a result, it is possible to prevent an occurrence of a production delay.

In the embodiment, a priority is determined in consideration of an operation status of a shaping machine. For example, even in a case where a stock shortage quantity with respect to an order quantity can be produced in terms of production capacity of the shaping machine, if an operation rate of the shaping machine is poor, it may not make a shipping deadline thereof. Even in such a case, in the embodiment, since the operation status of the shaping machine is reflected in the determination of the priority, it is possible to effectively prevent the occurrence of the production delay.

In the embodiment, the priority is determined in consideration of a state of a defect of the shaped article. For example, even in the case where the stock shortage quantity with respect to the order quantity can be produced in terms of the production capacity of the shaping machine, if the number of defective shaped articles or a defect rate thereof is large, it may not be in time for shipment. Even in such a case, in the embodiment, since the state of the defect of the shaped article is reflected in the determination of the priority, it is possible to effectively prevent the occurrence of the production delay.

In the embodiment, a component type whose production plan is changed is deleted from the priority ranking area AR1 of the production plan screen SC1. For example, in a case of a large-scale shaping factory, it is common for a user to change production plans of several tens of types of components a day. Therefore, if a component type whose production plan is changed is displayed as it is, it is difficult for the user to tell whether the component type is already subjected to a change in production plan, and may changes the production plan of the same shaped article again. On the other hand, in the embodiment, since the component type whose production plan is changed is deleted from the priority ranking area AR1, it is possible to prevent the production plan of the same shaped article from being changed repeatedly. In addition, since information displayed on the production plan screen SC1 can be reduced, a processing load of the screen generation unit 520 and the display unit 450 can be reduced.

In the embodiment, since the priority is displayed in the priority ranking area AR1 of the production plan screen SC1 in association with the type of the shaped article, a production status that cannot be recognized only by a priority ranking can be grasped in detail, such as to which degree the types having substantially the same priority exist. In addition, by displaying information on the priority rankings, the user can accurately grasp the priority rankings of the component types.

In the embodiment, since the priority is determined in accordance with a production difficulty level of the shaped article, for example, it is possible to assign a high priority to a shaped article that takes time for setup. Therefore, it is possible to effectively prevent the occurrence of the production delay.

In the embodiment, the priority is determined in accordance with information on an operation schedule of the mold and the shaping machine. Therefore, for example, in a case where the stock is small, it is possible to cope with a situation of preferentially changing a production plan when the number of shaping machines to which a mold can be attached or the number of idle molds is small.

The information on the operation schedule of the mold indicates, for example, the time during which the mold that is not currently attached to the shaping machine is used by a scheduled shipping date. For example, a situation may be considered in which a white gear is being produced and a black gear is being produced with the same mold at the same time. In such a case, even if the mold used in producing the white gear is damaged and the production is stopped in a situation in which the stock is small, the production plan cannot be changed because the black gear is being produced with the other mold, and a shipping delay may occur. For this reason, in a case where an abnormal stop occurs when the time a mold not currently attached to a shaping machine is used by the scheduled shipping date is short, it is necessary to take measures such as assigning a higher priority ranking even if the time of the abnormal stop is short. In such a situation, in the embodiment, since the operation schedule of the mold is reflected in the determination of the priority, it is possible to effectively prevent the occurrence of the production delay.

The information on the operation schedule of the shaping machine corresponding to the mold indicates, for example, the time in which the shaping machine corresponding to the mold is scheduled to produce another shaped article type by the scheduled shipping date without currently producing a target shaped article type. For example, it is assumed that there are a shaping machine A and a shaping machine B. The shaping machine A is producing a cap. The shaping machine B corresponds to the cap but has a corrected production plan and is producing a gear at present. At this time, when the cap is assigned a higher priority due to an abnormal stop of the shaping machine A, it is necessary to select a shaping machine other than the shaping machine A. However, the production plan of the shaping machine B is already corrected and thus cannot be corrected. In such a situation, it is necessary to switch the priority even when the progress rate is relatively high. In such a situation, in the embodiment, since the operation schedule of the shaping machine corresponding to the mold is reflected in the priority, it is possible to effectively prevent the occurrence of the production delay.

In the embodiment, the priority is determined by setting a weight of the information on the operation schedule of the mold to be larger than a weight of the information on the operation schedule of the shaping machine corresponding to the mold. For example, even when a shaping machine corresponding to a mold is not present in a factory of the company, the shaped article can be produced by using a shaping machine present in a subsidiary company or a subcontractor. However, in a case where there is no surplus of the corresponding mold, it is not possible to cope with the production by a subcontract or the like. Therefore, by setting the weight of the information on the operation schedule of the mold to be larger than the weight of the information on the operation schedule of the shaping machine, it is possible to cope with such a situation, and it is possible to effectively prevent the occurrence of the production delay.

Further, in the embodiment, the priority is determined in accordance with information on maintenance of the mold or the shaping machine. For example, during the production, in addition to regular maintenance, sudden maintenance such as replacement of a component of the shaping machine or cleaning of the mold may occur, and the number of production schedules may be insufficient depending on the number of steps of maintenance. However, in the embodiment, it is possible to effectively prevent the occurrence of the production delay by determining the priority according to maintenance of the mold or the shaping machine.

### B. Other Embodiments

(B1) In the above embodiment, in the production plan screen SC1, the priorities are displayed in association with the pieces of type information of the shaped articles. On the other hand, the priorities may not be displayed in the production plan screen SC1. In this case as well, as long as the pieces of type information are displayed side by side in the sequence of priority, the user can grasp the priority ranking of each piece of type information.

(B2) In the above embodiment, the priorities are determined using the various indices shown in FIGS. 3 and 4. On the other hand, it is not essential to use all of these indices, and the priorities may be determined using at least information on production deadlines of the shaped articles, information on stocks of the shaped articles, and information on production statuses of the shaped articles. In addition, the priority calculation method is not limited to the calculation method in the above embodiment. For example, the scores of the indices shown in FIGS. 4 and 5 may be multiplied by one another instead of being summed up. In addition, the weights for the scores of the indices are not essential.

(B3) In the above embodiment, the screen generation unit 520 deletes the component type whose production plan is changed from the production plan screen SC1. However, this processing is optional, and the screen generation unit 520 may not delete the component type. For example, the screen generation unit 520 may delete only a component type that is assigned a higher priority or priority ranking by change of a production plan thereof.

(B4) In the above embodiment, the display unit 450 serving as an output unit is provided in the terminal device 400. On the other hand, the display unit may be provided in the management device 500. In this case, an input device such as a mouse or a keyboard may be connected to the management device 500 as an input unit. The functions of the processing unit 501 and the storage unit 502 of the management device 500 may be provided in the terminal device 400.

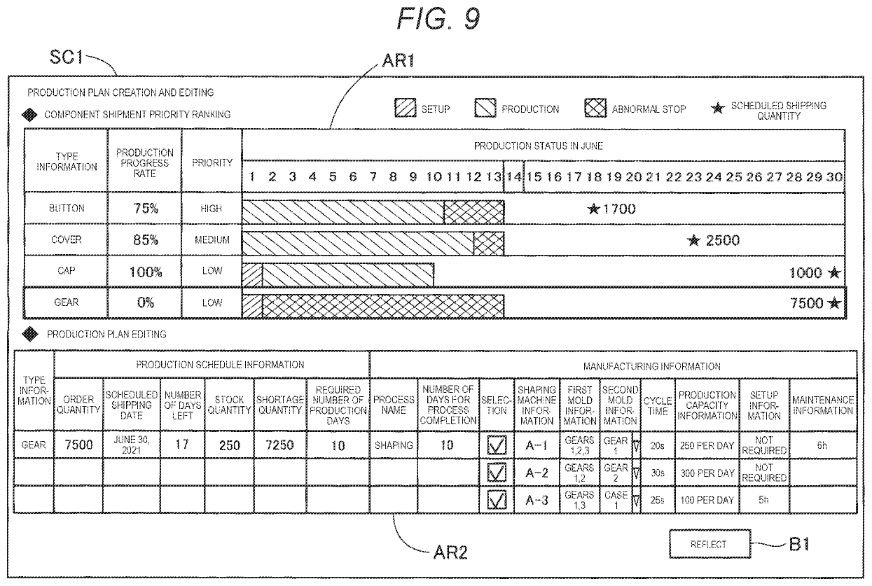

(B5) FIG. 9 is an explanatory diagram illustrating another example of the production plan screen SC1 subjected to a change in production plan. In the above embodiment, the screen generation unit 520 deletes the component type, whose production plan is changed, from the priority ranking area AR1. On the other hand, the screen generation unit 520 may highlight the component type whose production plan is changed with respect to other component types. FIG. 9 illustrates an example in which a display area “gear” is highlighted. This makes it easy to grasp the type of the shaped article affected by the change in the production plan. The type to be highlighted may be limited to a component type that is assigned a higher priority or priority ranking by the change of the production plan.

### C. Other Aspects

The present disclosure is not limited to the embodiments described above, and can be implemented in various forms without departing from the scope of the present disclosure. For example, technical features of the embodiments corresponding to technical features of the aspects described below can be appropriately replaced or combined in order to solve a part or all of the above problems or to achieve a part or all of the above effects. Unless described as essential in the present specification, the technical features can be deleted as appropriate.

(1) According to an aspect of the present disclosure, a production plan display system for a shaped article is provided. The production plan display system includes a display unit configured to display a screen showing production plans for shaped articles of a plurality of types. On the screen, information on the shaped articles of each type is displayed in accordance with priority rankings for changing the production plans. The priority rankings are determined in accordance with information on a production deadline of the shaped articles of each type, information on a stock of the shaped articles of each type, and information on a production status of the shaped articles of each type.

According to this aspect, since type information of the shaped articles is displayed according to the priority rankings determined based on the information on the production deadlines, the information on the available stocks, and the information on the production statuses, a user can change the production plan of the shaped article according to the priority ranking for which not only a current stock but also a current production status is taken into consideration. As a result, it is possible to prevent an occurrence of a production delay.

(2) In the above aspect, the information on the production status may include information on an operation status of a shaping machine. According to this aspect, it is possible to reflect the operation status of the shaping machine in the priority ranking. Therefore, it is possible to effectively prevent the occurrence of the production delay.

(3) In the above aspect, the information on the production status may include information on a defect of the shaped article. According to this aspect, it is possible to reflect a state of the defect of the shaped article in the priority ranking. Therefore, it is possible to effectively prevent the occurrence of the production delay.

(4) In the above aspect, information on the type whose production plan is changed may not be displayed on the screen. According to this aspect, it is possible to prevent the production plan of the same shaped article from being repeatedly changed.

(5) In the above aspect, information on the type whose production plan is changed may be highlighted on the screen. According to this aspect, it is easy to grasp the type of the shaped article affected by the change of the production plan.

(6) In the above aspect, information on the priority ranking may be displayed on the screen. According to this aspect, it is possible to accurately grasp the priority ranking of each type.

(7) In the above aspect, the priority rankings may be determined in accordance with information on a production difficulty level of the shaped articles of each type. According to this aspect, it is possible to reflect the production difficulty level of the shaped article in the priority ranking. Therefore, it is possible to effectively prevent the occurrence of the production delay.

(8) In the above aspect, the priority rankings may be determined in accordance with at least one of information on an operation schedule of a mold and information on an operation schedule of a shaping machine corresponding to the mold. According to this aspect, it is possible to reflect the operation schedule of the mold or the shaping machine in the priority ranking. Therefore, it is possible to effectively prevent the occurrence of the production delay.

(9) In the above aspect, a weight of the information on the operation schedule of the mold in determining the priority ranking may be larger than a weight of the information on the operation schedule of the shaping machine corresponding to the mold. According to this aspect, it is possible to effectively prevent the occurrence of the production delay.

(10) In the above aspect, the priority ranking may be determined in accordance with information on maintenance of a mold or a shaping machine. According to this aspect, it is possible to reflect the maintenance of the mold and the shaping machine in the priority ranking. Therefore, it is possible to effectively prevent the occurrence of the production delay.

What is claimed is:

1. A production plan display system for a shaped article, the system comprising:
a display unit configured to display a screen showing production plans for shaped articles of a plurality of types, wherein
on the screen, information on the shaped articles of each type is displayed in accordance with priority rankings for changing the production plans thereof, and
the priority rankings are determined in accordance with information on a production deadline of the shaped articles of each type, information on a stock of the shaped articles of each type, and information on a production status of the shaped articles of each type.

2. The production plan display system according to claim 1, wherein
the information on the production status includes information on an operation status of a shaping machine.

3. The production plan display system according to claim 1, wherein
the information on the production status includes information on a defect of the shaped articles.

4. The production plan display system according to claim 1, wherein
information on the type whose production plan is changed is not displayed on the screen.

5. The production plan display system according to claim 1, wherein
information on a type whose production plan is changed is highlighted on the screen.

6. The production plan display system according to claim 1, wherein
information on the priority rankings is displayed on the screen.

7. The production plan display system according to claim 1, wherein
the priority rankings are determined in accordance with information on a production difficulty level of the shaped articles of each type.

8. The production plan display system according to claim 1, wherein
the priority rankings are determined in accordance with at least one of information on an operation schedule of a mold and information on an operation schedule of a shaping machine corresponding to the mold.

9. The production plan display system according to claim 8, wherein
a weight of the information on the operation schedule of the mold in determining the priority ranking is larger than a weight of the information on the operation schedule of the shaping machine corresponding to the mold.

10. The production plan display system according to claim 1, wherein
the priority rankings are determined in accordance with information on maintenance of a mold or a shaping machine.
